(19) United States
(12) Patent Application Publication
(10) Pub. No.: US 2012/0223512 A1
(43) Pub. Date: Sep. 6, 2012

(54) ANGLED TEAR SEAMS FOR AIRBAG COVERS

(75) Inventors: Mathew Barr, Clarkston, MI (US); Jerome Fisher, Birmingham, MI (US); Daniel Vander Sluis, Rochester Hills, MI (US)

(73) Assignee: FAURECIA INTERIOR SYSTEMS, INC., Auburn Hills, MI (US)

(21) Appl. No.: 13/039,764

(22) Filed: Mar. 3, 2011

(51) Int. Cl. B60R 21/20; B60R 21/16

(52) U.S. Cl. 280/728.3; 280/743.1

(57) ABSTRACT

A panel for use over a vehicle airbag includes a non-visible tear seam for forming an airbag deployment opening. The tear seam may be formed by laser cutting through a panel substrate and into a panel covering using multiple laser power levels and may be formed at an angle of 85 degrees or less with respect to the substrate. Using multiple laser power levels can increase the accuracy and consistency of the residual wall thickness of the covering, and forming the tear seam at an angle of 85 degrees or less can improve tear seam function during deployment.

### TECHNICAL FIELD

The present disclosure relates generally to vehicle airbag coverings and tear seams for airbag coverings.

### BACKGROUND OF THE INVENTION

Inflatable airbags are safety devices commonly used in automobile interiors to help protect occupants in the event of a collision. They are most often installed near the front of the vehicle cabin as part of a steering wheel assembly or as part of an instrument panel, for example, to help prevent a driver or passenger from colliding with the steering wheel, windshield, or other interior components during the rapid vehicle deceleration that occurs during in a collision. Airbags may also be installed in other parts of the vehicle cabin such as beside the driver and passenger seating areas—e.g., near doors, windows, structural pillars, etc.—to help protect occupants when lateral forces are experienced during a collision. Airbags generally operate by inflating or deploying when triggered by a control signal and/or sensor that indicate that the vehicle is experiencing conditions indicative of a collision that is severe enough to warrant the supplemental protection of an airbag. When triggered, the airbag is typically filled with a rapidly expanding gas so that it inflates to provide a more forgiving barrier between occupants and the hard surfaces of the vehicle interior in a small fraction of a second.

Due to their utilitarian nature and one-time only emergency use, vehicle airbags are typically concealed from view, usually residing in a compartment behind or beneath a panel or other trim component that is more visually appealing. While deploying, an airbag must make its way into the vehicle cabin from its compartment, thus requiring an opening or passage between the compartment and cabin. Of course, for purposes of concealment, such an opening is desired only at the time of airbag deployment and not at any other time. Various techniques may be used to provide such an opening on demand. For example, an airbag door may be provided that covers the deployment opening during normal vehicle operation and that opens or otherwise uncovers the deployment opening when the airbag is triggered for inflation. However, airbag doors can be unsightly in a vehicle interior, even when decorated to match its surroundings, because their shape or outline may interrupt an otherwise smooth or continuous contour on a highly visible surface, such as the instrument panel or dashboard. Therefore, it may also be desirable to conceal the airbag door, where provided.

Another way to provide a deployment opening on demand is to form the opening while the airbag is deploying. For instance, the panel or other trim component behind which the airbag is concealed can be selectively breached during airbag deployment to form the opening. To accomplish this, the panel or component may be deliberately weakened at locations corresponding to the perimeter of the desired opening by providing a reduced material thickness, perforations, scoring, or other stress concentrators at these locations. When an airbag is triggered for deployment from behind a panel that has been deliberately weakened in this manner, the substantial forces generated by its rapid inflation can cause the panel to breach in the weakened areas, thereby forming an opening through which the airbag can deploy into the vehicle cabin. Again for aesthetic purposes, it may be desirable that any material thickness changes, perforations, scoring, or other such functional features in the panel be hidden from view.

### SUMMARY OF THE INVENTION

According to one embodiment, a panel for use over a vehicle airbag includes a substrate and a covering, each of which includes an outer surface and an inner surface. The covering is disposed over the substrate such that the inner surface of the covering faces towards the outer surface of the substrate. A tear seam is formed in the panel that extends from the inner surface of the substrate and at least partially through the covering. The tear seam includes a cut that forms an angle of about 85 degrees or less in relation to the inner surface of the substrate. The tear seam at least in part defines a deployment opening through the substrate and the covering for use during airbag inflation when the panel is installed in a vehicle.

According to another embodiment, a method of forming a tear seam in a panel for use over a vehicle airbag includes the steps of: (a) providing the panel having a covering disposed over a substrate, and (b) forming a cut in the panel from the substrate side of the panel. The cut is formed at least partially through the covering at a location corresponding to a pre-determined location for the tear seam and forms an angle of about 85 degrees or less in relation to an inner surface of the substrate.

According to another embodiment, a method of forming a tear seam in a panel for use over a vehicle airbag includes the steps of: (a) providing the panel having a covering disposed over a substrate, (b) forming a first portion of the tear seam in the form of a groove extending partially through the substrate at a location corresponding to a pre-determined location for the tear seam, and (c) laser cutting a second portion of the tear seam in the form of a plurality of spaced apart cuts. Each spaced apart cut extends from the first portion of the tear seam and at least partially through the covering, and the laser cutting is performed at two different power levels.

According to another embodiment, a panel for use over a vehicle airbag includes a substrate and a skin layer. The substrate has an outer surface and an inner surface, and the skin layer is disposed over the outer surface of the substrate. A tear seam extends partially through the panel from a first end at the inner surface of the substrate to a second end at the skin layer, and the second end is located outboard of the first end along at least a portion of the tear seam that corresponds with a leading edge of an airbag door.

### DESCRIPTION OF THE DRAWINGS

One or more preferred exemplary embodiments of the invention will hereinafter be described in conjunction with the appended drawings, wherein like designations denote like elements, and wherein:

FIG. 1 is a cutaway view of an exemplary instrument panel with a non-visible tear seam arranged over an airbag module;

FIG. 2 is an enlarged cross-sectional view of a portion of the instrument panel of FIG. 1 showing a tear seam including an angled cut;

FIG. 3 is a cross-sectional view along the tear seam of FIG. 2 showing a plurality of exemplary secondary cuts extending from a primary cut and partially through a covering; and

FIG. 4 is the portion of the instrument panel of FIG. 2 depicted during airbag deployment.

### DETAILED DESCRIPTION OF THE PREFERRED EMBODIMENT(S)

The structures and methods described below are directed to different embodiments of an airbag covering having an angled tear seam that provides desirable deployment characteristics during inflation of the airbag. Providing a tear seam in the form of weakened portions in an airbag-concealing panel or covering can be accomplished in a variety of ways. The selected techniques may depend on a variety of factors, such as the strength of the component materials, cost, complexity of the components, ease of manufacturing, or the resulting component aesthetics, to name a few. For example, where it is desired to form the deployment opening through a high-strength or high-stiffness material, the thickness of the material may require significant reduction at the desired opening perimeter to allow the airbag to break through. Other panel materials may have sufficiently low strength or have a thickness that is sufficiently low that an air bag can breach the material in the absence of additional weakening, though weakened areas may still be desirable to control the exact location of the formed opening. In some airbag applications, the airbag may be concealed behind multiple layers of materials, each layer requiring different types or levels of weakening in order to best form aligned deployment openings in each layer.

Among the techniques available is the forming of notches or locally reduced thickness areas at locations in the panel or covering corresponding to portions of the perimeter of the desired deployment opening. This type of weakening can be provided at the time the panel or covering is manufactured, or it may be added afterward by a secondary operation. For example, a notch may be molded into a molded plastic panel, or it may be formed in the panel after molding by cutting or otherwise reshaping the panel material. Depending on some of the factors mentioned above, some of the various methods that may be used to selectively weaken a panel or covering in a secondary operation include blade cutting or scoring, where the blade is a hot-knife or a cold-knife; ultrasonic cutting or scoring; laser cutting, scoring, perforation, or micro-perforation; other types of mechanical perforation; or milling. Other methods may be used as well.

Most of these techniques result in a discernible mark or line that is visible in the modified panel when viewed from the side of the panel on which the operation is performed. Therefore, these panel or covering modifications are typically performed on a non-visible surface—i.e., on the surface of the panel or covering opposite the surface that faces the interior of the vehicle cabin. In this manner, a concealing panel or covering for an airbag may be configured such that a deployment opening is formed through the panel at a pre-determined location during airbag deployment, the pre-determined location additionally being concealed from view in the vehicle cabin.

It is sometimes the case, however, that locating weakening cuts, scores, or notches on the underside of a covering is not enough to completely conceal their presence. Some coverings may experience a visual read-through or witness mark on the visible surface. For example, the same weakening that makes it possible for an airbag to breach the panel or covering may also cause localized variation in certain material behaviors, such as expansion and contraction, sagging, or reactions to applied stresses, for example.

As used herein, the term “tear seam” refers to any of the above-described structures, or other suitable ones, that are intended to weaken any portion of a vehicle component for the purpose of allowing an airbag to break, breach, split, divide, or otherwise make its way through or around the component during airbag deployment.

Certain types of materials that may be otherwise desirable for use in vehicle interiors can pose additional difficulties where is it necessary to form a tear seam in the material. For example, highly flexible or soft materials may be desirable vehicle interior materials because they can provide a luxurious feel. But such materials, particularly synthetic ones, may typically have properties that can hinder proper tear seam function, such as exceptionally high elongation before breaking. Typical solutions used to address poor tear seam function include forming the weakening cuts, scores, or notches of the tear seam further into the thickness of the material and/or closer together. But this may increase the likelihood of the read-through problem noted above, especially because such highly flexible materials are already particularly susceptible to read-through problems. Coupled with additional difficulties sometimes associated with cutting or otherwise forming tear seams in highly flexible materials and the desire of vehicle manufacturers to continuously reduce cost and weight of vehicle components—e.g., reducing the thicknesses of vehicle interior coverings—the selection of interior covering materials has been somewhat limited where the covering requires a tear seam to be included.

Using some of the structures and techniques disclosed below may help alleviate one or more of the difficulties associated with tear seams in highly flexible materials. As will be described in further detail, forming certain portions of tear seams with angled cuts can help improve tear seam function. Also, certain structures and geometries disclosed herein for the tear seam can help provide sufficient support to flexible decorative skin materials to help reduce read-through while maintaining proper tear seam function. Methods to form such tear seam structures have also been developed, including, for example, laser cutting using various laser power levels when forming different portions of the tear seam. Of course, the structures and methods described here are not limited to use with highly flexible materials, as they may also be used with other types of materials to improve manufacturing process windows, for example. While presented using a vehicle passenger side airbag as an example of one type of airbag that may benefit from the following disclosure, any type of panel for use over a vehicle airbag may benefit from the teachings herein.

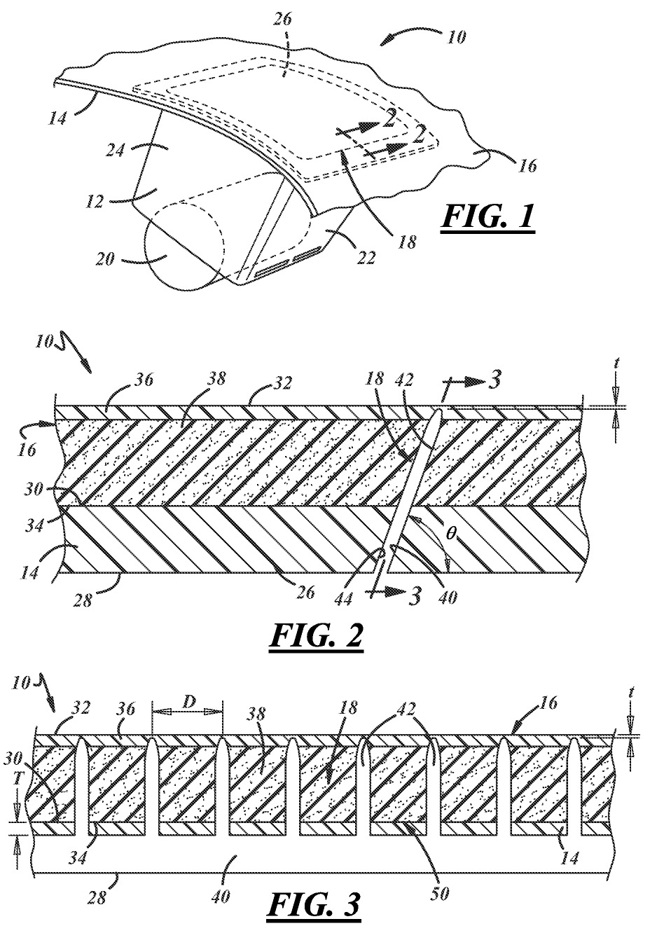

Referring now to FIG. 1, a cut-away view of an exemplary vehicle instrument panel 10 is shown with an airbag module 12 installed therebeneath. The portion of instrument panel 10 shown is the passenger side of the instrument panel. In this embodiment, instrument panel 10 includes substrate 14 and covering 16. Instrument panel 10 may include multiple layers of materials that may each include its own separately weakened portions provided for the formation of airbag deployment openings. Tear seam 18, shown as a hidden line in FIG. 1, is one such weakened portion, and is formed in instrument panel 10 so that it is not visible from the vehicle cabin when the instrument panel is installed in a vehicle. As indicated, tear seam 18 is generally rectangular in shape in this embodiment and located to correspond with underlying airbag module components. The tear seam may assume other known shapes, such as a U-shape, H-shape, or X-shape, to name a few examples.

Airbag module 12 is any component or device that includes an airbag arranged to deploy into the cabin of a vehicle when inflated. In this embodiment, airbag module 12 is a passenger airbag (PAB) module and includes an airbag canister 20 and a housing 22. The airbag canister 20 in this particular embodiment includes a folded or otherwise stowed airbag housed therein and is arranged and oriented such that when the airbag inflates, it extends away from the canister, toward the instrument panel 10, and toward the interior of the vehicle. Housing 22 is attached to the underside of instrument panel 10 and supports the airbag canister 20 beneath instrument panel 10. It may also include a chute 24 that helps to guide and control the direction of the airbag during deployment. This is of course only one version of an airbag module, while other modules may not include a canister or a separate housing and may include other types of components to compliment the functionality of the airbag.

In the exemplary embodiments presented below, an airbag door 26 is formed during airbag deployment when the tear seam functions to form the deployment opening. The air bag door 26 is formed from the portion of the substrate 14 lying inboard of the tear seam 18 before deployment of the airbag. Airbag door 26 may be attached to one or more portions of the substrate 14 lying outboard of the tear seam via a hinge or other type of tether that allows the door to move away from the deployment opening while remaining attached to the instrument panel so that it is not projected uncontrollably into the vehicle cabin. Alternatively, the tear seam 18 may be selectively interrupted to maintain attachment of the door to the instrument panel during airbag deployment.

FIG. 2 is a partial cross-sectional view of the instrument panel of FIG. 1 taken through the tear seam. It is noted that neither FIG. 2 nor any of the other figures provided are necessarily to scale, and some dimensions may be exaggerated for explanatory purposes.

As already noted, instrument panel 10 includes substrate 14 and covering 16 in the illustrated embodiment. Substrate 14 is the main component of instrument panel 10 to which other components may be attached and/or extend from for functional or aesthetic purposes, for example. A typical instrument panel substrate 14 may be constructed from a variety of materials depending on several design and cost considerations. Some exemplary substrate materials include rigid or semi-rigid thermoplastic materials such as polyolefin-based materials like thermoplastic olefins (TPOs) or polypropylene (PP). Other thermoplastic materials such as ABS or ABS/PC may also be used to form substrate 14. Thermoplastic materials may be filled or unfilled, depending on factors such as the required strength or stiffness of the substrate. Suitable filler materials typically include short or long glass fibers or mineral-based fillers. Polypropylene having filler material including long glass fibers in an amount of 20-30% by weight is one example of a suitable substrate material, but other polymeric or non-polymeric materials may be used. The thickness of the substrate may depend on the type of material used to make it, but generally ranges from 2.0 mm to 4.0 mm for polymer-based materials.

Substrate 14 includes inner and outer surfaces 28 and 30. As previously noted, substrate portion 26 lying inboard of tear seam 18 forms the airbag door during airbag deployment. The airbag module of FIG. 1 may be attached to the inner surface 28 at one or more locations lying outboard of the tear seam 18 and inboard of the tear seam in embodiments where the airbag module includes its own airbag door. In this embodiment, inner surface 28 may also be referred to as the bottom or lower surface due to its generally horizontal orientation, but some portions of exemplary instrument panels and their components may be oriented in other directions. Outer surface 30 in this particular embodiment is covered by covering 16 and is therefore not visible to vehicle occupants, though it faces in a direction toward the vehicle cabin.

Covering 16 overlies substrate 14 and, in this particular embodiment, is generally provided for decorative purposes, as it includes the visible surface of the instrument panel 10. Covering 16 is typically, but not always, fabricated to be generally more flexible than substrate 14, either by making it from lower modulus materials, by making it thinner than the substrate, or both. Some exemplary covering materials will be presented below. Covering 16 may be adhesively attached to the outer surface 30 of the substrate 14 with a suitable adhesive, or it may be attached by other techniques such as having its edges wrapped around edges of the substrate 14 and attached to the inner surface 28, for example. In one embodiment, a thin layer of a spray-on adhesive formulated to be compatible with the substrate material and the facing covering material is sufficient for attachment.

Covering 16 includes an outer surface 32 that faces toward the interior of the vehicle cabin and an inner surface 34 that lies adjacent substrate 14. In the particular embodiment of FIG. 2, covering 16 is a bi-layer material that includes a skin layer 36 and an inner layer 38. Skin layer 36 provides the outer surface 32 of the covering, which in this case is the visible or show surface of the instrument panel. It may be formed from any of a variety of materials typically used in automobile interiors, including thermoplastic olefins (TPOs), thermoplastic elastomers (TPEs), plasticized polyvinylchloride (PVC), thermoplastic polyurethanes (PUR), leather, simulated leather, or any combination thereof. Material selection may be based on a number of factors, including the desired type of texture for outer surface 32, the tactile “feel” of the material, cost, processability, etc. Olefin-based materials such as TPOs or other polymers based on ethylene, propylene, butylene, or butadiene or blends, alloys, or copolymers thereof may be preferred due to their low cost, low density, and wide available ranges of properties. Skin layer 36 may range in thickness from about 0.2 mm to about 1.0 mm, and preferably ranges from about 0.3 mm to about 0.7 mm. The thickness of layer 36 may depend on material choice and other factors, such as whether covering 16 is a multi-layer component as shown in this example. For example, in a different embodiment, covering 16 may include only a single layer of material, such as skin layer 36, in which case the thickness may be selected near the higher end of the range to provide sufficient material thickness for the tear seam. Covering layer 16 may also be an intermediate layer of the overall instrument panel and have one or more other layers disposed over it.

Inner layer 38, as provided in the illustrated embodiment, lies between substrate 14 and skin layer 36. Inner layer 38 may be included to provide a different tactile “feel” to the covering 16 and to the overall instrument panel than if the skin layer were attached directly to the more rigid substrate 14. Layer 38 may also be included as an intermediate layer that aids in adhesion of the skin layer 36 to the instrument panel by providing a material that can be sufficiently adhered to both the skin layer 36 and the substrate. Layer 38 may be separately adhered, co-extruded, laminated, or otherwise attached to skin layer 36 to form covering 16 as a unitary component, or layer 38 may be a separate layer altogether. Inner layer 38 can include other functionality as well, such as leveling uneven areas in the underlying substrate, helping to conceal substrate features, and providing generally more structure to coverings that utilize skin layers that may be too thin and/or flexible to be practical for use in a manufacturing environment. In another embodiment, inner layer 38 may be formed in place by disposing an expandable material such as polyurethane foam between skin layer 36 and substrate 14.

In this exemplary embodiment, inner layer 38 provides the inner surface 34 of the covering, which is adjacent and facing the substrate 14. It may be formed from any of a variety of materials, but polymeric foam materials may be preferred to provide a soft but resilient feel to the instrument panel. Exemplary materials for inner layer 38 may include nearly any type of polymer foam. Polyolefin-based foams may be used, for example, including foam materials based on polyethylene (PE), polypropylene (PP), TPOs, or alloys or blends thereof, such as a PE/PP alloy. Other types of polymer foams include polyurethane foam, acrylic-based foams, and polyester foams, to name a few. Some of these materials may be cross-linked for additional resilience, and they may include open- or closed-cell structures. Other non-foam materials such as felt or textile fibers may be used as well. Inner layer 38 may range in thickness from about 0.5 mm up to about 5.0 mm or higher, depending on the desired “feel” of the instrument panel, for example. A more typical inner layer thickness may be chosen to provide an overall covering thickness that ranges from about 1.0 mm to about 4.0 mm. For example, in one embodiment, covering 16 has an overall thickness of about 2.0 mm, where the skin layer 36 is about 1.0 mm thick and the inner layer 38 is about 1.0 mm thick. In another embodiment, the skin layer is about 0.5 mm thick, and the inner layer is about 3.5 mm thick, so that the overall covering thickness is 4.0 mm. Of course, these are non-limiting examples, as there are several suitable combinations of layer thicknesses.

Covering 16 is not limited to the bi-layer configuration shown and described. As already noted, skin layer 36 can itself be the covering in some instances. In addition, covering 16 may include more than two layers to provide a more complex tactile feel to the instrument panel, to include a bulk layer of inexpensive material, or for other reasons. The following description of tear seams applies to all instrument panels and other types of panels that may conceal an airbag, regardless of the number of layers.

Tear seam 18 may be described with continued reference to FIG. 2 and additional reference to FIG. 3. Tear seam 18 may be formed in the instrument panel 10 and extends from the inner surface 28 of the substrate 14 and at least partially through the covering 16. In this embodiment, tear seam 18 extends through the thickness of the substrate 14, through the thickness of the inner layer 38, and partially through the skin layer 36. In some embodiments, microperforation is possible such that the tear seam extends through the skin layer forming openings in the outer surface of the skin layer that are sufficiently small to be non-visible. The depicted tear seam 18 includes a plurality of cuts, including primary cut 40 and secondary cuts 42, with the distinction best shown in FIG. 3. Any of the cuts may be formed at an angle θ in relation to the substrate surface 28. In this embodiment, all of the cuts arranged along the tear seam 18 are formed at the angle θ. Angle θ may range from about 45 degrees to 90 degrees, although in some applications, angles less than 45 degrees may be suitable. In one preferred embodiment, angle θ is about 85 degrees or less, and in another preferred embodiment is within the range of 45 degrees to 85 degrees. In other preferred embodiments angle θ may be within the range from about 65 to about 75 degrees and even more preferably is about 70 degrees. The cuts 40 and/or 42 may be formed at the preferred angle(s) along a leading edge 44 of airbag door 26; i.e., the portion of the substrate at the tear seam and on the inboard side of the tear seam prior to airbag deployment. The leading edge 44 of airbag door 26 is designed to breach first and swing away from the remainder of the instrument panel when the airbag deploys. Of course, angled cuts may be formed anywhere else along the tear seam as well. The functionality of the angled cuts will be described in further detail below. Tear seam 18 may be formed in covering 16 by any of the previously mentioned techniques, but in the depicted embodiment it is formed by laser cutting.

Primary cut 40 may be formed in the inner surface 28 of substrate 14 and extends at least partially through the thickness of the substrate. In one embodiment, it extends only partially through the thickness of substrate 14, as best shown on FIG. 3. The residual wall thickness T of the substrate in the region of the primary cut may range from about 0.5 mm to about 2.0 mm depending on the types of materials used and other factors. Generally, though, with rigid or semi-rigid thermoplastics, a preferable residual wall thickness T for the substrate ranges from about 1.0 mm to about 1.5 mm to provide sufficient strength to the tear seam to prevent it from being compromised by vehicle occupants leaning on the airbag door, for example. In one embodiment, primary cut 40 is in the form of a groove that extends along the length of the tear seam 18. It may be a continuous groove that forms a substantially constant residual wall thickness T in the substrate, or it may include one or more discontinuities such as bridges for added strength or areas with a thicker residual wall thickness T to form integral hinges for the air bag door, for example. It may form an angle θ in the range of about 45 to about 90 degrees, or within any of the other ranges noted above, and may be formed by laser cutting or any other technique. In fact, primary cut 40 does not have to be cut into an existing surface. It may be formed in the inner surface of the substrate by any suitable means, such as being molded into the substrate during an injection molding process or by other forming techniques.

Secondary cuts 42 generally extend from primary cut 40 and at least partially through covering 16. In the illustrated embodiment, each of secondary cuts 42 extends through the residual wall thickness T of the substrate, through the thickness of inner layer 38, and partially through skin layer 36. In the embodiment shown, each cut 42 is in the form of an elongated finger extending away from the primary cut 40 and toward the skin layer 36 at the same angle as the primary cut 40. Each finger includes a slightly rounded end and forms a blind hole in this embodiment. Each of the depicted secondary cuts 42 extends approximately the same distance through the skin layer 36, defining a residual wall thickness t for the skin layer. Residual wall thickness t may range from about 0.1 mm to about 0.3 mm, depending on the thickness of skin layer 36 and other factors. The preferred residual wall thickness t ranges from about 0.1 mm to about 0.2 mm for highly flexible skin layers, such as those fabricated from certain TPO formulations. Secondary cuts 42 in this embodiment are spaced apart from each other with about the same distance D between each consecutive cut 42. Distance D may range from about 1.0 mm to about 5.0 mm, and with highly flexible skin layers may range from about 2.5 mm to about 3.5 mm. Lower values for D are preferable to improve tear seam function, but as with residual wall thicknesses, values that are too low may cause visual defects on the visible surface of the skin layer. Of course, the depicted cuts 42 and their arrangement is exemplary, as the angle θ may vary or be different from the angle of the primary cut, the spacing between cuts may be irregular, and residual wall thickness t may vary from cut to cut. Though typically formed by laser cutting, skilled artisans may recognize other techniques to form secondary cuts such as those shown in the figures, or may recognize other cut shapes that can be formed using other cutting methods.

Forming portions of the tear seam 18 at an angle θ≦85°, particularly secondary cuts 42 in the examples shown in the figures, has been shown experimentally to improve tear seam function. Though the exact mechanism may not be fully understood, there are a number of factors thought to be positively affected by such angled cuts. Experimental airbag deployments have been conducted with tear seam cuts formed normal to substrate surfaces. In some of these experiments, particularly with high elongation grades of materials, delamination at the interface of the skin layer and the inner layer would sometimes occur and/or the skin layer would not properly tear, instead only stretching excessively with the airbag deploying beneath the skin layer and over the substrate in some cases. Observation showed indications that there was a region slightly outboard of the tear seam where stresses in the skin layer were higher than in the region directly over the tear seam (i.e., directly over the leading edge of the airbag door). Forming the tear seam so that the stress-concentrating portions of the tear seam, such as the ends of the secondary cuts that extend into the skin layer, are located outboard of the leading edge of the airbag door places the stress-concentrating portions in a higher stress region and may cause the skin layer to reach its failure point with less elongation because of the higher rate of stress increase in the higher stress region.

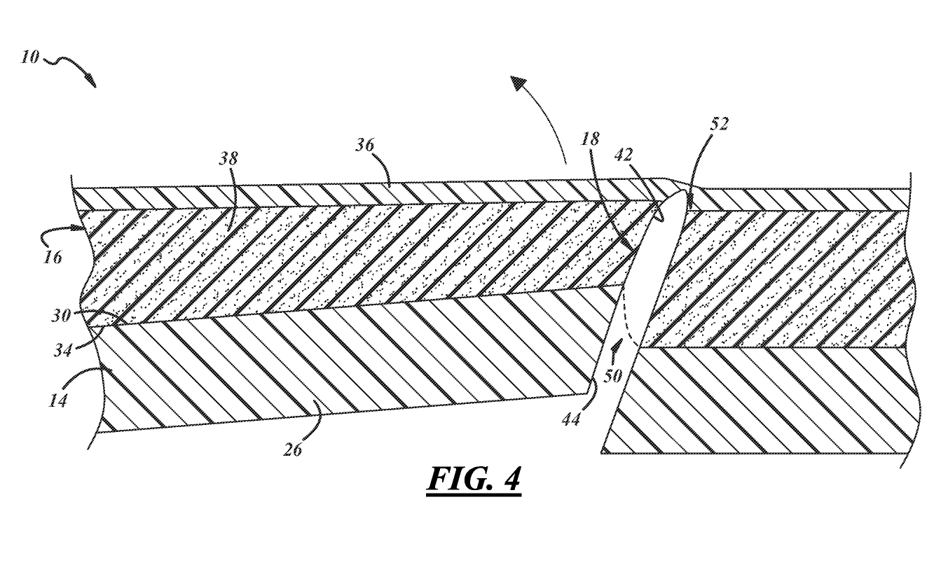

FIG. 4 shows tear seam 18 in the initial stages of airbag deployment. The dashed line shown across the tear seam represents a web region 50 along the inner surface 34 of inner layer 38. In particular, web region 50 is the portion of inner surface 34 that extends between successive second cuts 42 along the tear seam 18 (web region 50 is also labeled in FIG. 3 for clarity). FIG. 4 depicts the manner in which inner layer 38 may compress and elongate in different portions as the airbag begins to deploy. For example, as airbag deployment begins, the portion of the inner layer 38 located above leading edge 44 of airbag door 26 begins compressing as shown, while web region 50 is placed in tension. Forming the tear seam 18 with cuts at non-normal angles as shown can provide an acute angle where the leading edge 44 of the airbag door 26 intersects substrate outer surface 30. This sharper-than-90° angle provides a more effective stress concentrator to promote faster tear initiation of inner layer 38; i.e., tearing of inner layer 38 along web region 50 between successive second cuts 42 can begin before any inter-layer delamination occurs.

A further possible advantage of the angled tear seam cut may include a more favorable distribution of stress at an interface 52 of the skin layer 36 and inner layer 38 on the side of the tear seam opposite the leading edge 44 of the door 26. For example, a tear seam formed from cuts normal to the substrate surfaces places the interface 52 in a pure peeling mode, which is a worst case condition for adhesive bonds such as may exist between the skin and inner layers. A pure peeling mode concentrates the entire applied load along at line at the edge of the interface. A tear seam formed at an angle such as θ≦85° places interface 52 into a mode that includes a reduced peeling component (normal to the inner layer surface) and an increased shear component (parallel to the inner layer surface), spreading the applied force over an area extending into the interface from its edge. Stated another way, the tension in the portion of skin layer 36 that bridges the tear seam during airbag deployment has a larger component parallel to the inner layer surface than it would with a tear seam formed with cuts normal to the substrate.

A method of forming a tear seam, such as the above-described tear seams, in a panel for use over a vehicle airbag may be described as well. In one embodiment, the method may broadly include the steps of: (a) providing a panel having a covering disposed over a substrate, (b) forming a primary cut in an inner surface of the substrate of the panel, and (c) forming one or more secondary cuts in the panel from the substrate side of the panel.

Another exemplary method of forming a tear seam may be described as broadly including the steps of: (a) providing a panel having a covering disposed over a substrate; (b) forming a first portion of the tear seam extending partially through the substrate; and (c) laser cutting a second portion of the tear seam that extends from the first portion of the tear seam and at least partially through the covering, the laser cutting being performed at two different power levels. Of course other method steps may be added or some steps may be omitted in either of these examples, and the steps are not necessarily performed in the order listed. For example, step (b) may be performed before step (a) in each case.

Where laser cutting is used to form one or more portions of the tear seam, it may be described in terms of power levels. For purposes of this disclosure, a “power level” associated with laser cutting is the effective power setting for the laser cutter. For example, a 1500 W laser may be set to produce a laser beam at some given percentage of its full power capacity, and the laser may be configured with a particular duty cycle, which is a fraction of a given time period that power is being delivered. Any given power level may be achieved by altering one or more of these variables. For example a 1500 W laser can cut at a power level of 300 W by operating the laser at 100% available power and a 20% duty cycle; at 20% power and 100% duty cycle; or at 50% power and a 40% duty cycle, to name a few options, though other practical considerations and process parameters may affect which combination of variables are settled on.

Laser cutting tear seams in multi-layer panels where each layer includes different types of materials presents some challenges. For example, cutting through a glass-fiber filled polymer substrate may require more energy than cutting through or into a softer skin layer or a highly porous inner layer. Moreover, skin layers are typically relatively thin, and when forming non-visible tear seams, the depth of the laser cut in the skin layer may need to be controlled precisely in order to achieve a tear seam that will function properly and that will not show through on the visible surface of the skin layer. This may be difficult with a single laser power level that is capable of cutting through the substrate, even when the laser is pulsed to better control the depth of cut. One technique developed to address the problem is using a sensor opposite the laser beam to detect a portion of the light energy transmitted through the covering once the substrate is cut through. As the distance from the laser light to the sensor decreases, the sensor signal increases. When the signal reaches a pre-determined value, the laser indexes to the next cutting position. One problem with this technique is that it may be affected by the transmissivity of the covering materials; i.e. an indicator of the amount of light that passes through the covering that can reach the sensor. Transmissivity can vary from covering to covering, for example when one covering is a different color than another. And some covering materials, such as highly porous inner layers and thin skin layers, have such high transmissivity that the sensor will stop the laser cutting and index to the next cutting location as soon as the substrate is cut through, so that little or none of the covering is cut. Other materials may have such low transmissivity that the sensor may not detect sufficient laser light until the outer surface of the covering is cut through.

The exemplary methods presented here may include laser cutting the tear seam using multiple laser power levels. For example, either of the primary cut or the secondary cuts described above may be formed in a panel utilizing multiple different laser power levels. In one embodiment the primary cut is formed partially through the substrate using industry-standard laser power levels that are known in the art. Of course, as already mentioned, the primary cut does not have to be a cut at all, but can be otherwise formed in the inner substrate surface. After the primary cut is formed, which may be before or after the covering is disposed over the substrate, a residual wall thickness (T in FIG. 3) is present in the substrate, as already described. The secondary cuts can be formed through the residual wall thickness of the substrate at a power level that is significantly lower than the industry-standard power levels typically used to score a substrate. For example, the laser power level may be reduced to 50% or less of that used for the primary cut. In one embodiment the power level used to cut through the residual wall thickness of the substrate is within a range from about 15% to about 30%, or about 20% or less, of the power level used to form the primary cut. With certain material and thickness combinations in the covering, the power level used to cut the remainder of the secondary cut may be within a range from about 40% to about 80%, or about 70% or less, of the power level used to cut through the residual wall thickness of the substrate. In one embodiment the power level used to form the portion of the secondary cut extending into the covering is in a range from about 5% to about 25%, or about 15% or less, of the power level used to form the primary cut. A sensor opposite the laser, as described above, may be used to determine when each secondary cut is complete. In one embodiment, the covering materials may be selected based partially on the transmissivity of the materials such that the sensor can effectively detect when the laser has cut through the covering to the desired residual wall thickness. The above power level ranges are non-limiting, as some substrates and covering combinations may require laser power levels that differ to greater or lesser degrees while forming the tear seam.

Depending on the type of laser cutting equipment, this and other exemplary methods of forming tear seam cuts can be performed with any number of passes of the laser. A “pass” as used here is defined as one instance of the cutting laser moving along a predetermined path or series of predetermined locations without retracing any portion of the path or returning to any of the series of locations. Retracing any portion of a path already traced constitutes an additional pass for that portion, as does returning to any of the series of predetermined locations. For example, in embodiments in which the primary cut includes laser cutting, the primary cut may be performed in a single pass to arrive at the desired substrate residual wall thickness, or it may be performed in multiple passes in applications where larger amounts of material are being removed. In one embodiment, one pass is included for each laser power level used to form the tear seam. For example, when laser cutting a secondary cut through the residual wall thickness of the substrate and partially through the covering using two different laser power levels, the secondary cut may be formed with two passes of the laser, with each pass using one of the different laser power levels. Of course, not every pass is required to use a different power level, as it may sometimes be useful to perform multiple passes at the same laser power level. In one embodiment where the primary cut is not preformed in the panel, the tear seam may be laser cut in three passes with the laser at a reduced power level during each subsequent pass.

It may be possible with certain laser cutting equipment to form the complete tear seam in a single pass. For instance, the laser power level may be varied within a single pass. By way of example, reference will be made to FIG. 3. To form the portion of the exemplary tear seam shown in the figure, laser cutting may be performed on the panel 10 with the laser cutting from the bottom of the panel, as oriented in the figure, and following a path moving from left to right or right to left. The laser may be at a first power level at portions of the path where no second cut is desired, cutting the substrate 14 to form primary cut 40 to a depth corresponding to residual wall thickness T. When the laser reaches a location where a second cut 42 is desired, the laser power level may be reduced to a second power level, after the substrate at that location is cut to residual wall thickness T, to begin making the second cut 42. After the laser cuts through the residual wall thickness T and reaches the covering 16 at that location, the laser power level may be reduced to a third power level and the covering 16 can be cut until the desired covering residual wall thickness t is obtained. The laser can then move further along its path, returning to the first power level until it moves a distance D to the next location for another second cut 42. This of course is only an exemplary embodiment, and additional steps may be added or some steps omitted. For example, primary cut 40 may be pre-formed and the laser may index from location to location where secondary cuts 42 are desired and cut through the residual wall thickness T and partially through the covering 16 using two different power levels at each location before moving to the next. Any number of power levels may be used during a single pass, any number of passes may be completed at a given power level, and multiple passes may be performed with one or more of the passes using multiple power levels.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A panel for use over a vehicle airbag, comprising:
a substrate having an outer surface and an inner surface;
a covering disposed over the outer surface of the substrate, the covering having an outer surface and an opposite inner surface that faces towards the outer surface of the substrate; and
a tear seam formed in the panel that extends from the inner surface of the substrate and at least partially through the covering, the tear seam comprising a cut that forms an angle of about 85 degrees or less in relation to the inner surface of the substrate, wherein the tear seam at least in part defines a deployment opening through the substrate and the covering for use during airbag inflation when the panel is installed in a vehicle.

2. A panel as recited in claim 1, wherein the cut extends through the substrate and at least partially through the covering.

3. A panel as recited in claim 1, wherein the covering comprises:
a skin layer that includes the outer surface of the covering; and
an inner layer that includes the inner surface of the covering, wherein the cut extends through the inner layer and at least partially into the skin layer.

4. A panel as recited in claim 1, wherein the covering comprises an olefin-based material.

5. A panel as recited in claim 1, wherein the angle is within a range of about 45 degrees to about 85 degrees.

6. A panel as recited in claim 1, wherein the angle is within a range of about 65 degrees to about 75 degrees.

7. A panel as recited in claim 1, wherein the tear seam comprises:
a primary cut extending from the inner surface of the substrate and at least partially through the substrate; and
a secondary cut extending from the primary cut and at least partially through the covering, wherein at least one of the cuts forms an angle of about 85 degrees or less in relation to the inner surface of the substrate.

8. A panel as recited in claim 7, wherein the primary and secondary cuts are arranged at substantially the same angle.

9. A panel as recited in claim 7, wherein the tear seam comprises a plurality of spaced apart secondary cuts extending from the primary cut and one or more of the secondary cuts extends at least partially through the covering.

10. A method of forming a tear seam in a panel for use over a vehicle airbag, comprising the steps of:
(a) providing a panel having a covering disposed over a substrate; and
(b) forming a cut in the panel from the substrate side of the panel and at least partially through the covering at a location corresponding to a pre-determined location for the tear seam such that the cut forms an angle of about 85 degrees or less in relation to an inner surface of the substrate.

11. The method of claim 10, further comprising the step of forming a primary cut in the inner surface of the substrate before step (b), the primary cut extending partially through the substrate to the pre-determined location of step (b).

12. The method of claim 11, wherein the primary cut is formed at substantially the same angle as the cut formed in step (b).

13. The method of claim 10, wherein step (b) comprises forming the cut such that the covering at the cut has a residual wall thickness in a range from about 0.1 mm to 0.3 mm.

14. The method of claim 10, wherein step (b) comprises laser cutting through the substrate at a first power level and laser cutting at least partially through the covering at a second power level that is lower than the first power level.

15. The method of claim 10, further comprising the step of forming a plurality of cuts in the panel from the substrate side of the panel and at least partially through the covering, wherein the plurality of cuts is arranged along the pre-determined location for the tear seam such that one or more of the cuts forms an angle of 85 degrees or less in relation to the surface of the substrate.

16. The method of claim 10, wherein the covering comprises a skin layer and an inner layer disposed between the skin layer and the substrate, and step (b) includes forming the cut in the panel from the substrate side of the panel through the inner layer and at least partially through the skin layer.

17. The method of claim 10, wherein the angle is within a range of about 45 degrees to about 85 degrees.

18. A panel for use over a vehicle airbag, comprising:
a substrate having an outer surface and an inner surface;
a skin layer disposed over the outer surface of the substrate; and
a tear seam extending partially through the panel from a first end at the inner surface of the substrate to a second end at the skin layer, wherein the second end is located outboard of the first end along at least a portion of the tear seam that corresponds with a leading edge of an airbag door.

19. A panel as recited in claim 18, wherein the tear seam is formed at angle relative to the inner surface of the substrate that is within a range from about 45 degrees to 85 degrees.

20. A panel as recited in claim 18, wherein the tear seam is continuous at the first end and comprises spaced cuts at the second end.
